(19) United States
(12) Patent Application Publication
(10) Pub. No.: US 2014/0320605 A1
(43) Pub. Date: Oct. 30, 2014

(54) Compound structured light projection system for 3-D surface profiling

(71) Applicant: Philip Martin Johnson, Durham, NH (US)

(72) Inventor: Philip Martin Johnson, Durham, NH (US)

(21) Appl. No.: 13/870,118

(22) Filed: Apr. 25, 2013

(51) Int. Cl. H04N 13/02

(52) U.S. Cl. CPC H04N 13/0242
USPC 348/47

(57) ABSTRACT

A method and apparatus is provided for high speed, non-contact method of measuring the 3-D coordinates of a dense grid of points on a surface, including high accuracy interpolation between grid points. A plurality of pulsed laser sub-projectors sequentially illuminates a plurality of discrete Gray code bar pattern transparencies carried on a spinning circular code disk to project high frame rate structured light. The structured light is reflected by the surface and recorded at high signal-to-noise ratio by a plurality of high frame rate digital cameras, then decoded and interpolated by electronic signal processing. A numerical formula is derived for numbers of equally spaced discrete code patterns on the code disk that allow each camera to receive pulses from all sub-projectors and all patterns at a constant frame rate. Methods to derive an extended complementary Gray code pattern sequence and to normalize measured signal amplitudes are presented.

### CROSS-REFERENCE TO RELATED APPLICATIONS

This application claims the benefit of Provisional Patent Application Ser. No. 61/641,083 filed May 1, 2012, the entire contents of which are hereby incorporated by reference.

### STATEMENT OF GOVERNMENT INTEREST

This invention was made without United States Government assistance.

### BACKGROUND OF THE INVENTION

In many manufacturing processes there is a need for automated non-contact 3-D surface profile measuring instruments with improved accuracy and speed. Typical uses of these instruments are for quality control inspection of, for example, stamped metal parts, welds, automobile door closures, bored hole position and dimensional accuracy, and automobile wheel alignment. Such instruments may be stationary and take measurements of stationary or moving objects, or may be mounted on robotic arms to rapidly scan stationary or moving objects from different angles. Robotic arms with many degrees of freedom are now common in automated factories and present optimum mounting platforms for accurate and fast optical profiling instruments. The 3-D profiling instrument itself must represent the best compromise between measurement accuracy, volume coverage rate (speed), reliability, size, weight and cost.

The present state of the art in 3-D surface profiling for manufacturing purposes is exemplified by two general approaches: 1) conventional optical stereo photogrammetry with two or more digital video cameras separated by known baselines (triangulation is used for the depth coordinate) and 2) a combination of one or more digital cameras and a “structured light” projector. The term structured light refers to optical projection of a sequence of one or more optical images having a known spatial structure for the purpose of determining the angular position of an object, or part of an object, in the beam. For surface profiling, what is measured is the intensity of the reflected projector light on each of a large number of camera pixels for a sequence of projected patterns. When the intensity sequence for each pixel is decoded, it provides a two-dimensional measurement of the angular position of that pixel's image on the object with respect to the projector's optical axis. The two-dimensional angular position of the same pixel with respect to the camera's optical axis is determined simply by its location coordinates in the focal plane array.

A structured light projector with absolute position encoding can either replace one of the cameras in stereo photogrammetry or improve operation with the same number of cameras. An example of this is described in U.S. Pat. Nos. 8,233,156 B2 and 8,243,289 B2 for wheel alignment. Even if the structured light cannot measure absolute angles with respect to the projector, the patterns reflected from the object can provide a means for faster and more reliable image registration between two or more cameras. However, overall speed and accuracy can benefit if the structured light can measure absolute angles. It is therefore an object of this invention to describe a faster and more accurate means for measuring absolute two-dimensional angular positions of small regions of a surface, both with respect to the optical axes of one or more structured light projectors and also with respect to the optical axes of one or more electronic cameras, where the small regions of the surface are defined by camera pixel images.

U.S. Pat. No. 3,662,180, 1972, may have been the first to describe means for projecting a sequence of binary Gray code intensity patterns for determining the absolute angular position of a remote receiver with respect to a projector's optical axis. FIG. 2, FIG. 3 and FIG. 4 were taken from a selected page of the above prior art patent. These show an example drawing of the Gray code and an example of the different received light pulse sequences that result from changing receiver position in the projected beam.

Prior art U.S. Pat. No. 3,799,675, 1974 describes a method of projecting Gray code pattern slides interspersed with clear reference slides such that the amplitude of the Gray code pulses at the receiver can be normalized by dividing by the amplitude of the most recent reference pulse. This was found to be a valuable technique for minimizing measurement errors caused by the amplitude modulation effect of atmospheric turbulence (scintillation). In terms of the present need for accurate 3-D surface profiling, atmospheric turbulence is not normally an issue. But variations of surface reflectivity and slope on the object can cause similar temporal variations in the energy received by the camera pixels when there is even a small amount of relative rotational or translational motion between a projector/camera assembly and the object being profiled. Some means for intensity normalization are therefore required even when atmospheric turbulence effects are negligible. Interspersing clear reference slides between the Gray code slides as in U.S. Pat. No. 3,799,675 (1974) as well as in U.S. Pat. No. 4,100,404 (1978) and U.S. Pat. No. 5,410,399 (1995) is effective, but it either requires a larger code disk or limits the size of the individual patterns to be projected. When encoding a small angular field this is not a problem, but for 3-D surface profiling it would be a serious limitation. It is therefore an object of this invention to provide a method of minimizing errors caused by variations in surface reflectivity and slope by intensity normalization without requiring clear reference slides.

U.S. Pat. No. 4,100,404 (1978) describes a Gray code structured light projector that encodes two orthogonal dimensions by projecting two sequences of one-dimensional bar pattern slides on a spinning disk. One sequence has the center bar edges radially oriented and the other with the center bar edges tangentially oriented. A very short (60 nanosecond) pulse-width laser diode source was required to freeze the motion of the radially oriented edges. Interspersed clear reference slides were used as discussed. There were 60 discrete slide positions on the disk, of which 16 carried Gray code slides. One clear reference slide was added between each group of four Gray code slides.

The laser diode source described in U.S. Pat. No. 4,100,404 is actually a stack of five small edge-emitting laser diodes with a total of 100 W of peak output power in a 60 ns pulse, or six microjoules (μJ) of energy. Unfortunately that pulse energy is nearly three orders of magnitude too low for 3-D surface profiling, because a much wider angle beam must be projected and then reflected by the object and scattered into an even wider angle before a camera lens can collect a small portion of its energy and focus it onto a single pixel. To meet surface profiling requirements, a 60 ns pulse-width laser source would need a peak power of nearly 10,000 watts, making it too large and expensive for commercial application. It is therefore an object of this invention to define a structured light projector that can encode two orthogonal dimensions without requiring radial-edged slides, and as a result able to operate with commercially available longer pulse-width and typically 1,000 watt peak power laser diode array sources that are very efficient in electrical to optical power conversion.

U.S. Pat. No. 4,175,862 (1979) appears to have been the first description of a structured light projector in conjunction with a group of passive camera sensors system for the purpose of measuring 3-D surface profiles. This patent describes several different space coding methods, including one using natural binary code, but does not describe a binary Gray code. Natural binary code is not desirable when used in structured light projectors, because multiple pattern edge transitions can occur at some angular positions, whereas the Gray code allows no more than one edge transition to occur at any angle [Reference 3]. It is an object of this invention to continue to exploit the Gray code and any variations that retain its benefits.

U.S. Pat. No. 4,871,256 (1989) is useful prior art for the present invention in that it describes the basic means by which a projector with a spinning disk carrying a sequence of one-dimensional patterns with no radially oriented edges can be used to encode two dimensions. This is accomplished by use of two or more strobe light sources and two or more projection lenses, with the optical axes of each source and projection lens assembly spaced by 90 degrees with respect to the center of the disk. This is directly applicable to the present invention. However, it does not describe the detailed means for creating a practical projector usable for high speed 3-D surface profiling. It is therefore another object of this invention to provide a detailed description of a practical projector.

U.S. Pat. No. 5,410,399 (1995) describes a method for improving the accuracy of Gray code encoding by interpolating a remote receiver's position within each coarse quantization element defined by a sequence of projected bar patterns. The general concept is applicable to 3-D surface profiling, but the specific method claimed is based on assumptions that the projector's illumination source emits very coherent and long wave infrared laser radiation, and that the projection optics provide perfectly diffraction limited optical resolution over the entire projected field. These are very restrictive and undesirable constraints with respect to 3-D surface profiling. Coherent laser illumination is not desirable for surface profiling, not only because it results in unwanted speckle intensity variations in the light reflected from the surface, but primarily because when used to project the image of a sharp edge it creates an image intensity at the geometrical location of the edge that is only 25% of maximum intensity, instead of 50% of maximum intensity as with incoherent illumination. As shown in U.S. Pat. No. 5,410,399, it is possible to still accurately locate edge positions by projecting complementary pairs of patterns. This is done by defining the edge location as the position where the intensity measured for both patterns in a pair is equal. However, the asymmetrical shape of the intensity curves created by coherent illumination increase the difficulty of achieving accurate interpolation inside of a digital resolution element. Coherent illumination also requires the projection of clear reference slides for intensity normalization in any interpolation algorithm.

It is an object of the present invention to minimize the coherence of laser illumination used in the projector. It is also an object of this invention to provide an intensity-normalizing function without the use of clear reference slides.

There have been several alternative coding schemes reported in the literature and in issued U.S. patents regarding 3-D surface profiling. Relatively long period phase shifted intensity sinusoids and relatively long period phase shifted trapezoidal or triangular waves have been discussed. With the recent availability of electronically controlled digital scene projectors, researchers have experimented with appending sinusoidal “phase shift” intensity patterns to a Gray code sequence and using phase shifted long period triangular wave intensity patterns instead of Gray code. For example, see Reference [1] on sinusoidal phase shift coding and Reference [2] for triangular wave phase shifting.

In general, phase-shifted sinusoidal intensity waveforms or phase-shifted long period triangular waveforms can provide improved immunity to defocus in a 3-D profiling application, as well as reducing the required number of projected patterns. However, they inherently are susceptible to reduced accuracy when sensed by the newer high frame rate but lower sensitivity CMOS cameras, simply a result of low intensity gradients in the projected images and higher readout noise in CMOS cameras. That is, when the projected intensity is made to vary gradually from minimum to maximum over a longer distance on the object, the intensity slope is lower and, given the same amount of camera pixel readout noise, there is a greater position uncertainty in the recorded data. Despite improved immunity to defocus, these coding schemes make it difficult to achieve best accuracy unless the signal to noise ratio is very high.

Future high speed surface profiling instruments will very likely need CMOS cameras in order to meet frame rate requirements. Even though CMOS cameras can use larger pixel dimensions to somewhat mitigate the sensitivity problem, a surface profiling system using them for high frame rate may be forced to operate its projection lens at a lower f-number (larger relative aperture), which may eliminate any advantage in defocus immunity that might be thought to occur from the sinusoidal or long period triangular intensity patterns. It is therefore an object of the present invention to take advantage of the much higher frame rates available with CMOS cameras and at the same time maximum accuracy in the presence of higher readout noise by making use of a larger number of projected patterns with higher intensity gradients.

There are also now commercial 3-D profiling products that make use of laser-illuminated line patterns, such as in U.S. Pat. Nos. 6,191,850 and 8,233,156. Although these types of patterns require only modest laser power, they inherently provide only a sparse sampling of an object surface, in other words, they do not encode the space between the lines. It is an object of this invention to provide a method for uniform and dense surface profile measurement data over all of the interior of a defined-coverage solid angle.

Many current structured light projectors for 3-D surface profiling make use of Digital Mirror Device (DMD) technology, such as in the Texas Instruments' DLP®. This technology avoids the sparse spatial sampling problem of projected line patterns, but because the DMD mirror-switching rate for an XGA format (1024×768 mirrors) is typically limited to below 5,000 Hz, a structured light projector using this technology for future 3-D profiling would seriously limit 3-D measurement rate, even with laser illumination. That means that future profiling systems using DMD technology would not be able to take advantage of the very high frame rates achievable with CMOS digital cameras. For example, the commercially available Vision Research Phantom v1610 widescreen CMOS camera can operate at a frame rate of 19,800 Hz for a focal plane size of 1,024×800 pixels, and can provide even higher rates at lower resolutions. This is about four times the frame rate available with a micro-mirror DMD array at the same resolution, illustrating the need for an improved and different projection method that can take advantage of high CMOS camera rates. It is therefore an object of this invention to provide means to create a pattern projection rate of at least 10,000 Hz, double the available DMD rate of 5,000 Hz for the same resolution and compatible with commercially available CMOS cameras.

### BRIEF SUMMARY OF THE INVENTION

A compound structured light projector system for the purpose of 3-D surface profiling consists of a compound projector assembly, a camera assembly, and a digital processor. The compound projector consists of four or more sub-projectors having optical axes parallel to each other and also to the axis of a circular spinning code disk, on which there are a number of slide transparencies in the form of discrete periodic bar patterns organized according to an extended complementary Gray code sequence. The illumination source in each sub-projector is a stacked array of low coherence, high power, pulsed edge-emitting laser diodes, each of which has its output radiation collimated by one of several miniature cylindrical lenses arranged in an array. The collimated light produced by each laser diode and its associated cylindrical lens is then integrated in a reflective light pipe and focused on the slide disk by a biconvex condensing lens. The result is uniform, incoherent, and intense illumination of the slides.

The bars in each slide on the spinning code disk are all tangentially oriented; that is, all have their long edges perpendicular to a radius of the code disk at their centers. As a result, translational motion of the projected patterns on the object being measured is negligible for a laser pulse duration of a few microseconds, making it possible to use commercially available “quasi-CW” mode high power and high efficiency laser diode arrays.

Each periodic bar pattern on the code disk has a unique combination of spatial periods and phase shifts, defined by the new extended complementary Gray code sequence of this invention. The extended Gray code sequence makes use of the fact that all of the projected bar images will be detected and measured by digital cameras, each containing a focal plane array of square pixels spaced at a consistent pixel pitch. Each square camera pixel spatially integrates the energy reflected from a small part of the object being measured, that small part being defined by a back-projected image of the pixel itself. The result is that measured pixel signal changes as a linear function of its position relative to a projected bar pattern edge over a fixed distance equal to the width of the projected pixel image, a fact that is used to advantage in this invention to provide for optimum interpolation in the receiver decoding process. The extended complementary Gray code is defined such that the bar patterns have the correct spatial periods and phase shifts to allow for optimum decoding and interpolation of received pixel signals in the system's digital processor.

Correct periods and phases of the bar code patterns are assured when the following rules are observed: 1) starting the sequence at the least significant bit end, there must be six slides consisting of three phase shifted complementary pairs, each of which when projected has the same spatial period of eight times a magnified camera pixel size on the object. 2) the fourth and all subsequent pattern pairs in the extended Gray code sequence have no phase shifts, and have periods that double with respect to the preceding pattern until the last period is equal to or greater than the required field of view as in standard complementary Gray code.

The sub-projectors are equally spaced at 90 degree positions with respect to the disk axis so that during a disk rotation any single pattern on the spinning code disk will be imaged on the object being profiled at least twice in each of two orthogonal dimensions. The camera assembly consists of at least two, and desirably four high frame rate CMOS digital cameras spaced at 90 degree angles with respect to the center of the code disk. Each camera is separated laterally by a calibrated baseline from the axis of the code disk, and views essentially the same angular space as the sub-projectors so as to provide depth measurement to points on the surface by triangulation. A digital processor receives, stores, decodes and processes measured data from the cameras and provides synchronization between projector and camera assemblies.

In order to allow each of the four or more cameras viewing reflected light from the object being profiled to maintain a constant frame rate and minimize readout noise, the camera exposure times are made only slightly longer than a projected pulse duration, which requires the pulses from each laser source to be precisely multiplexed to occur at equal intervals. In addition, each laser pulse is made to occur at the time when a slide is exactly centered on the optical axis of the sub-projector emitting the pulse. These conditions are created by ensuring that the disk rotation rate is constant and the total number of slide positions on the disk is given by the formula N_{POSITIONS}=4m+1, m being an integer, for the case of four equally spaced sub-projectors and 3-D surface profiling.

### BRIEF DESCRIPTION OF THE DRAWINGS

FIG. 1 is a block diagram showing the components of the Compound Structured Light Projector System when in use for 3-D surface profiling.

FIG. 2 shows a 1972 prior art schematic illustration of the Gray code structure.

FIG. 3 shows a 1972 prior art schematic of a remote receiver that decodes its position with respect to a Gray code projector.

FIG. 4 shows 1972 prior art waveforms of the different received light pulse sequences that result from changing receiver position with respect to a Gray code projector.

FIG. 5 shows a bird's eye view of the interior structure of the Compound Projector, oriented for projecting downward onto a surface being profiled. Dashed lines and arrows define the direction of cross section plane c-c.

FIG. 6 is a cross section view of the Compound Projector in the c-c plane.

FIG. 7 shows a magnified cross section view of the laser end of a typical sub-projector, including the laser diode stack, an array of miniature cylindrical lenses, and part of the rectangular light pipe. The plane of the cross section is as defined in FIG. 5.

FIG. 8 is an elevation cross-section view of the Compound Structured Light Projector System showing two of the four sub-projectors and two of the associated four cameras in position for 3-D surface profiling.

FIG. 9A shows a plan view of the compound projector and four cameras. A typical Gray code bar pattern image is projected by a sub-projector onto a flat horizontal surface.

FIG. 9B shows the projector and camera configuration and the same Gray code bar pattern image when the code disk has rotated 90 degrees and the same slide is projected by a different sub-projector.

FIG. 10 is a plan view of an extended Gray code slide disk with 25 discrete slide positions.

FIG. 11 is a schematic drawing of the imaging geometry for a structured light projector projecting a bar pattern onto a translucent screen object, and a focal plane array camera viewing the back side of the screen from the same distance.

FIG. 12 shows a series of five waveforms representing the extended Gray code pattern sequence of the invention.

FIG. 13 shows part of an ideal image of a minimum period bar pattern as projected onto a flat surface, with an ideal image of a square camera pixel also imaged on the same surface.

FIG. 14 shows trapezoidal waveforms of measured camera pixel output representing the effect of spatial integration in the camera pixels on the ideal waveforms of FIG. 12.

FIG. 15A is a timing diagram that shows the multiplexed pulses from four different lasers.

FIG. 15B is a timing diagram that shows how all of the cameras can operate at a constant frame rate with an exposure time only slightly greater than the laser pulse width.

FIG. 16 is a schematic drawing of a 90 degree sector of a code disk, used for derivation of equations for allowable number of slide patterns on the disk.

### DETAILED DESCRIPTION OF THE INVENTION

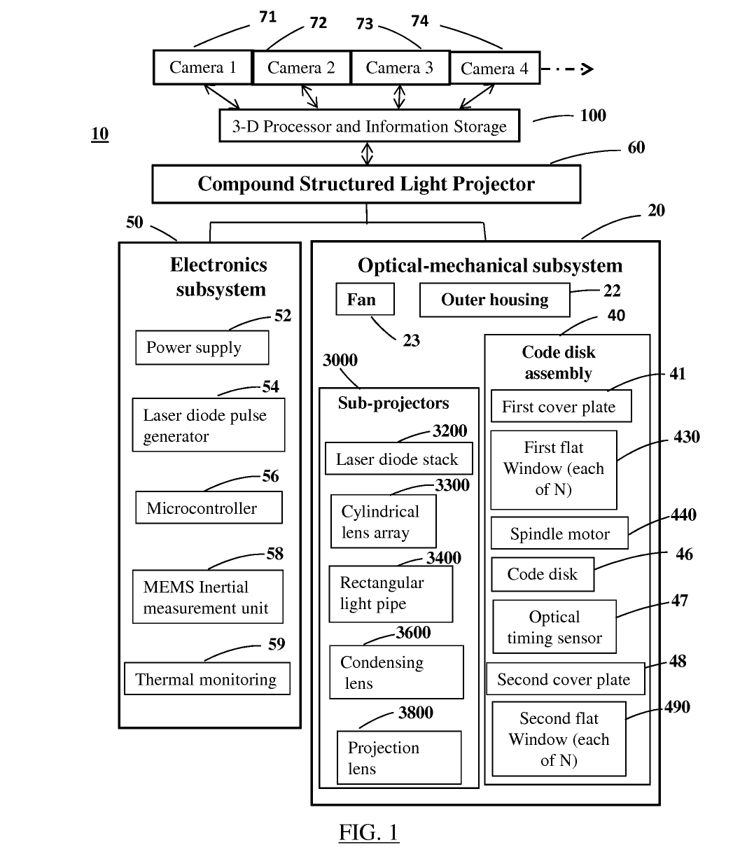

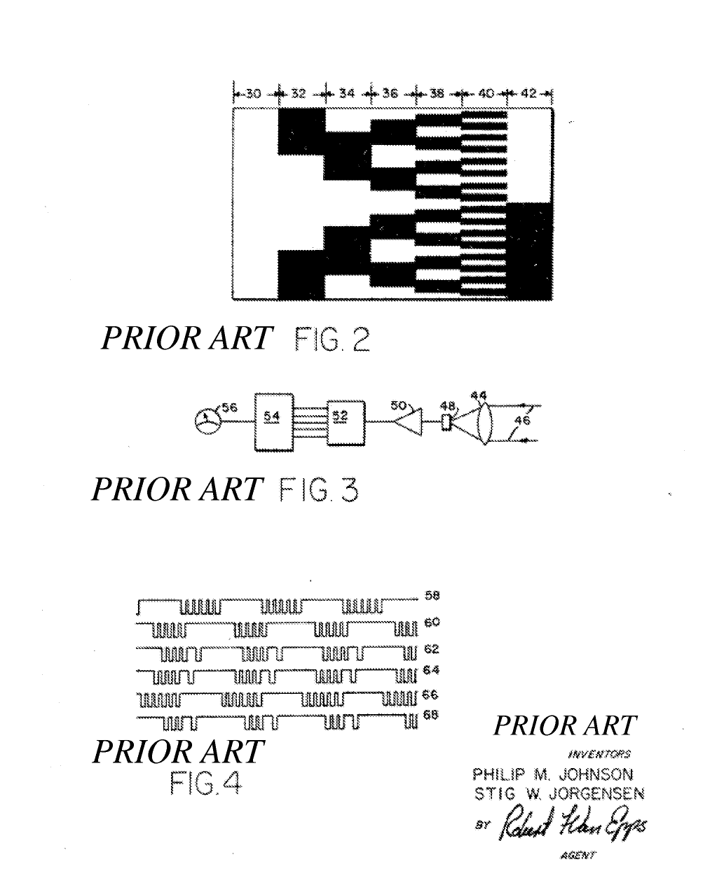

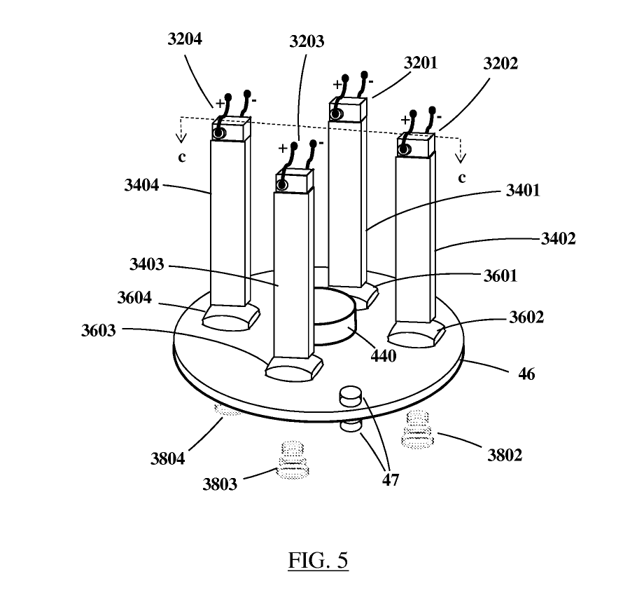

Referring now to FIG. 1, a system embodying the principles of the present invention is illustrated in block diagram form and designated as 10. The entire system 10 includes a compound structured light projector 60, a plurality of high speed digital cameras 71,72,73,74, etc. and 3-D digital processor and information storage unit 100. The compound structured light projector 60 comprises two major sub-systems: electronics subsystem 50 and optical-mechanical subsystem 20.

In electronics subsystem 50, power supply 52 converts available input power to various direct current (DC) voltages. Laser diode pulse generator 54 creates pulses at a rate of 12,000 Hz to serve four laser diode stacks in sequence, each being pulsed at 3,000 Hz with approximately 130 amperes of current at 16 volts for a duration of 4 μs. Microcontroller 56 is a small electronic processor that controls the operation of the compound structured light projector 60, including motor speed control and communication with the overall system's 3-D processor and information storage computer 100. Micro electro-mechanical system (MEMS) inertial measurement unit (IMU) 58 provides measurement of the overall system's rotational and translational motion with respect to inertial coordinates. Thermal monitoring function 59 provides temperature measurements to allow correction for absolute and differential thermal deformations of the mounting structure.

FIG. 5 is a bird's eye view of the compound projector without outer housing 22. It illustrates how four individual sub-projectors with laser diode stacks 3201, 3202, 3203 and 3204, rectangular light pipes 3401, 3402, 3403 and 3404, and bi-convex condensing lenses 3601, 3602, 3603 and 3604 are arranged with respect to the code disk 46 in the preferred embodiment of the invention. Each laser diode stack contains an array of cylindrical collimating lenses that cannot be seen in FIG. 5 but are shown in FIG. 7.

The laser end of a general sub-projector is shown in more detail in cross-section c-c of FIG. 7: a general laser stack identified as 3200, a general collimating cylindrical lens array identified as 3300 and a general rectangular light pipe identified as 3400. This figure shows cross-sections of collimated sheet beams emitting from the lens array at slightly different directions as a result of minor differences in the alignment of the individual lenses with the individual edge-emitting diodes. Multiple reflections inside the light pipe result in uniform and low coherence illumination at the pipe exit. Laser diode stack suppliers generally change the number of individual diodes in a stack to create different levels of output power, keeping a fixed emitting length. Most efficient use of available laser energy therefore requires non-square rectangular shapes for the light pipes 3400 and biconvex condensing lenses 3600. Because the outer borders of the Gray code slides are most conveniently square to assure symmetry in the projected patterns, the curvature of the surfaces in the biconvex condensing lenses may be different in each dimension.

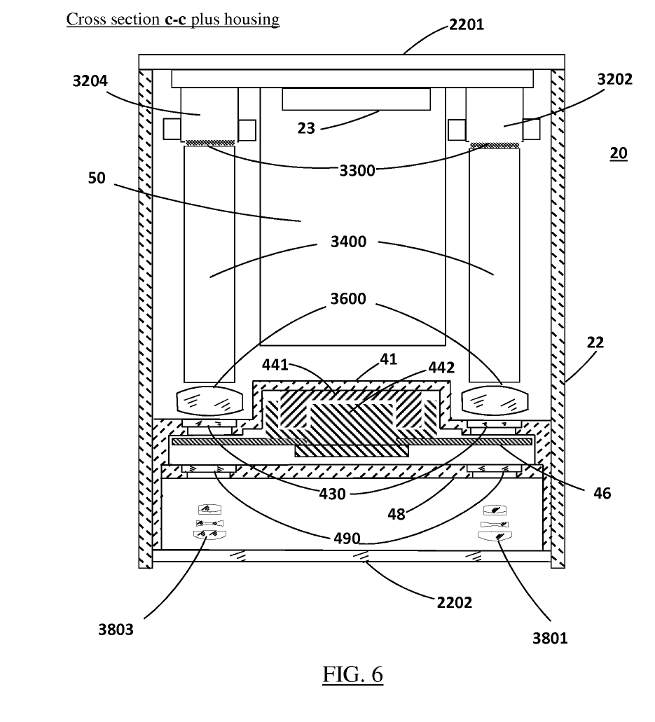

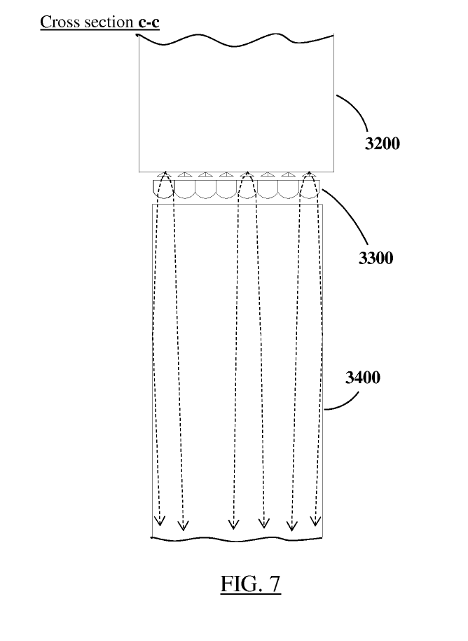

Projection lenses 3802, 3803, and 3804 for the identical sub-projectors are shown in FIG. 5, while the projection lens associated with laser diode stack 3201, light pipe 3401, and bi-convex condensing lens 3601 is hidden by code disk 46. Plane cc as defined in FIG. 5 is the cross-section plane illustrated in FIG. 6 and FIG. 7.

Returning to the block diagram in FIG. 1 and the cross-section view of the compound projector in FIG. 6, the optical-mechanical subsystem 20 is seen to include a protective outer housing 22 consisting of circular top plate 2201 and bottom plane parallel plate transparent window 2202 and four sub-projectors 3000 as discussed in the previous paragraph. The code disk assembly 40 consists of first cover plate 41, four parallel plate entrance windows 430, a spindle motor 440 consisting of stator 441 attached to first cover plate 41, and rotor 442 with hub for code disk mounting. Four parallel plate output windows 490 are mounted in second cover plate 48. The sealed cavity created by first cover plate 41, entrance windows 430, second cover plate 48 and exit windows 49 encases the spinning code disk 46 with minimum volume so as to eliminate contamination of the slide patterns and to minimize drag caused by centrifugal pumping of boundary layer air.

Again in FIG. 6, the code disk 46 is made of glass 110 mm in diameter and 1 mm thick, and the spindle motor is a commercially available computer hard drive motor rotating at 7,200 RPM (120 Hz). Such motors have carefully engineered components for minimum wobble, minimum friction drag, long life, and low cost. For a common so-called 3½ inch hard disk drive, the spindle motor may rotate three 0.8 mm thick disks 95 mm in diameter. In this invention, a similar standard computer hard disk spindle motor is used to drive a single slightly larger 110 mm glass code disk. The larger disk diameter should cause no problem because its polar moment of inertia is only 75% of that for three 95 mm disks, and its surface area is less than one half of three 95 mm hard disks. The slide patterns on disk 46 are preferably made of chromium thin films, with edge location precision+/−1 μm.

The preferred laser diode stack for each of the four mini-projectors is a commercially available DILAS Conduction-Cooled QCW (quasi-continuous wave) Vertical Diode Laser Stack operating at 808 nm wavelength with nominally 8 laser bars of 11 mm length spaced apart by 1.7 mm and collimated by miniature cylindrical lens arrays 3300 shown in the expanded cross-section of FIG. 7. Similar stacked diode arrays are sold by other suppliers. The preferred laser pulse width is 4 microseconds (μs) at a repetition rate of 120×25=3,000 Hz, which results in a duty cycle factor of 1.2% per laser array, less than the maximum rated 2%.

The overall pattern projection rate for the four sub-projectors is 12,000 Hz, slightly greater than twice the maximum rate of current DLP® micro-mirror arrays, achieving one of the objects of this invention. Preferred peak output power from each diode stack is 1,000 W. The average output power per stack is equal to the peak power times the duty cycle factor, or 1,000 W×0.012=12 W. This type of stack has a high power conversion efficiency, approximately 50%, so the power input for each of the four laser diode stacks is 24 W and the heat dissipation is 12 W. The four stacks in the overall compound projector will therefore require 96 W of input pulsed electrical power and dissipate 48 W of that as heat at the stacks themselves. There will be an additional roughly 12 W heat load because roughly half of the average power incident on the patterns on the code disk will be reflected by the chrome in the individual slide patterns, with perhaps half of that returned to the diode stacks. This moderate heat load is removed by small fan 23 as seen in FIG. 1 and FIG. 6.

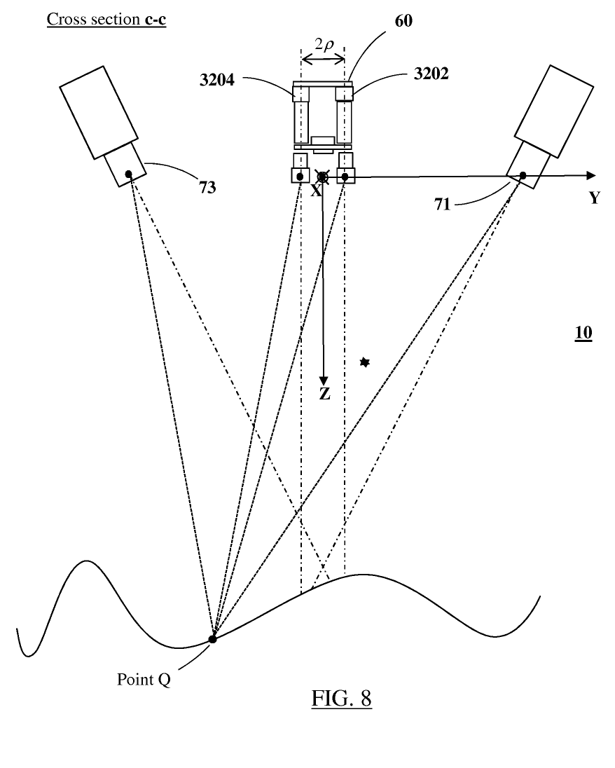

FIG. 8 shows a cross-section plane c-c view of compound projector 60 plus cameras 71 and 73 in use for surface profiling. There are five triangulation baselines—one between the two cameras, two between one camera and the two sub projectors, and two more between the other camera and each sub-projector. In the absence of thermal effects, system symmetry would reduce the number of different baseline lengths to three, but in general, thermal monitoring function 59 will be needed to allow for differential expansion compensation. Lasers 3202 and 3204 always project bar patterns with the long side of the bars being perpendicular to plane c-c which contains the optical axes of both sub-projectors and both cameras, whereas lasers 3201 and 3203 not shown in FIG. 8 always project patterns with the long side of the bars parallel to plane c-c.

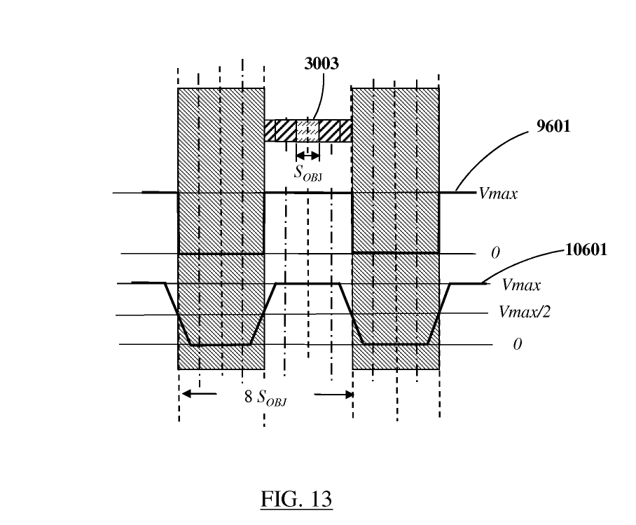

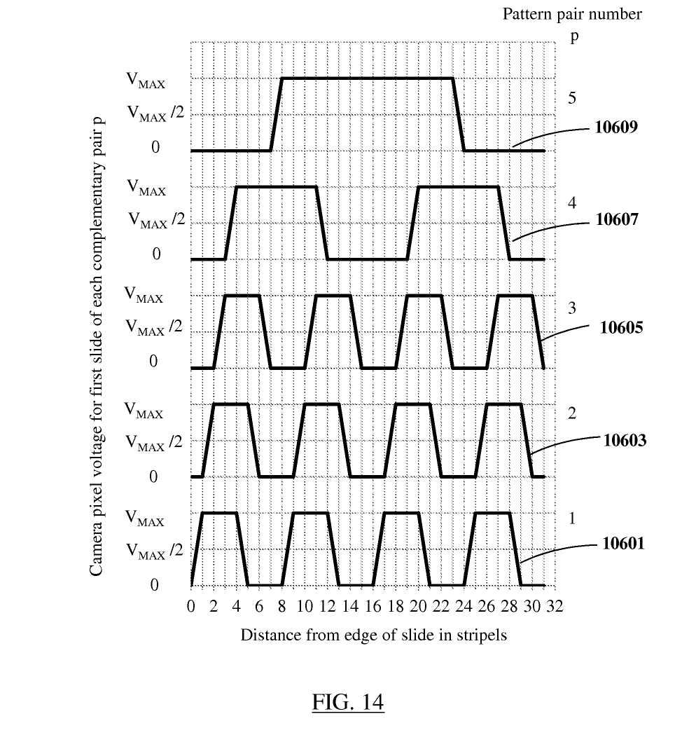

The two cameras and two projectors shown in the plane c-c will provide four two-dimensional angular measurements to use in the depth estimation for any arbitrary point Q on the surface, within the limitations of the beam extents of the projectors and the field of view limits of the cameras. That is, two-dimensional independent absolute angle measurements are made with respect to the optical axes of each. When the two cameras and the two projectors in the orthogonal plane are also considered, it can be seen that there is a potential for this invention to significantly improve 3-D measurement accuracy through averaging. Note that accuracy improvement through averaging independent measurements is additional to that resulting from improved position interpolation. Interpolation will be described in later paragraphs and by FIG. 13 and FIG. 14.

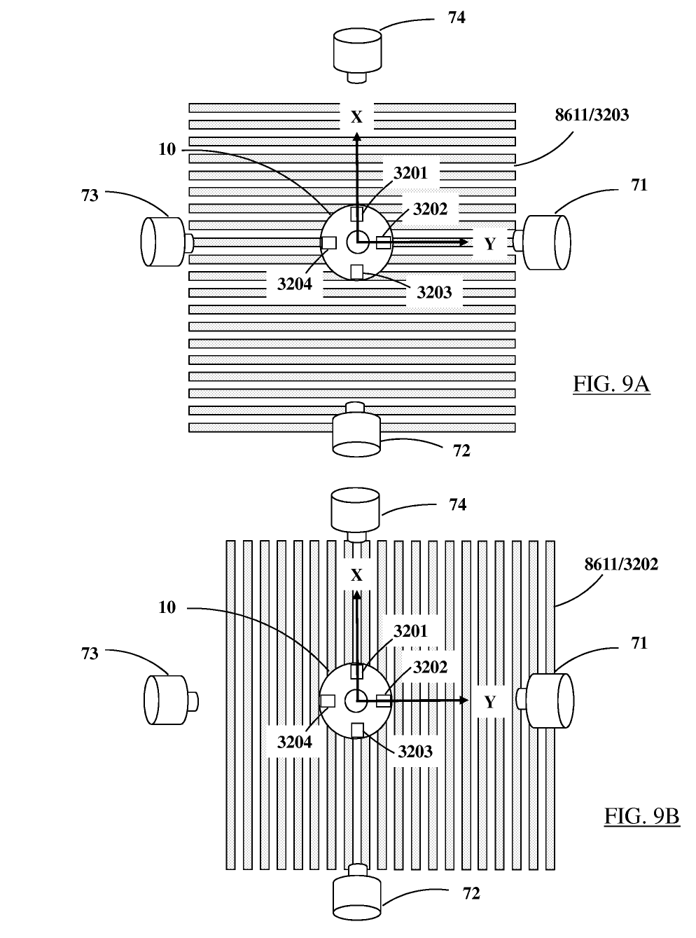

FIGS. 9A and 9B are plan views of two orthogonal patterns that are different projections of a same slide at different times. Bar pattern image 8611/3203 in FIG. 9A is the image of slide 4611 projected by laser 3203 onto a flat horizontal surface. Bar pattern image 8611/3201 is the image of slide 4611 when it has been rotated 90 degrees by code disk rotation and projected by laser 3202 onto the same flat surface. Because the optical axes of all sub-projectors are parallel and at the same radius ρ from the axis of the code disk as seen in FIG. 9, each projected pattern is also offset from the Z axis by distance ρ, which is the radius to slide centers on the slide disk. In the preferred embodiment of this invention ρ=48 mm. There is thus not perfect overlap of all projected patterns, but for a projected image extent of 480 mm the offset is only 10%.

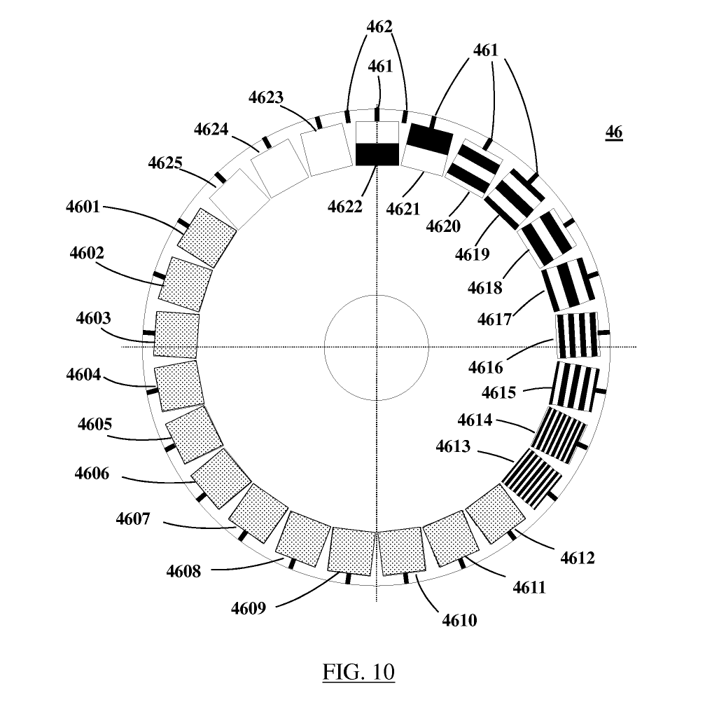

Now referring to FIG. 10 where there is shown a plan view of the preferred embodiment of code disk 46, it can be seen that it has 25 discrete slide positions, with slides 4623, 4624 and 4625 being blank reserves and not part of the code. The remaining 22 slide positions, starting with slide 4601 and ending with slide 4622, contain pairs of slides arranged in the extended complementary Gray code sequence of this invention. This sequence starts with a first pair consisting of slides 4601 and 4602 and ends with the last and most significant pair consisting of slides 4621 and 4622. Note that slides 4601 through 4612 have bar patterns too fine to be resolved in the drawing and have to be represented by an artificial dot pattern, even though each slide actually has a unique bar pattern. To see a portion of a magnified image of slide 4601, please refer ahead to FIG. 13. To see two magnified ideal images of the bar pattern on slide 4611, for example, please refer back to FIGS. 9A and 9B respectively.

Each even numbered slide shown in FIG. 10 has a transmission versus distance pattern that is the complement of that for the next lower odd numbered slide. Slide pattern 4602 is the complement of slide pattern 4601, which means that if the optical transmission is equal to one for a point displaced from the edge of pattern 4601 by a distance x, the transmission is equal to zero for the same displacement on pattern 4602. The outer dimensions of each slide pattern are 10.24 mm by 10.24 mm, although this size may be reduced in other embodiments in which larger numbers of slide positions are desired for higher slide projection rates.

Note that there is a small opaque timing mark 461 associated with every slide position on the disk and two additional master index marks 462, one placed midway between slides 4621 and 4622 and the other midway between slides 4622 and 4623. These timing marks are sensed by optical timing sensor 47 shown in FIG. 1 and FIG. 5 in order to have both accurate pulse strobe times, a disk speed reference, and a master position index. This approach has worked well in prior art Gray code projector hardware.

With respect to intensity normalization, it can be seen that there are no clear reference patterns between the complementary pairs of Gray code patterns on the code disk shown in FIG. 10, a significant difference from the prior art approach of U.S. Pat. No. 5,410,399. The three spare slides 4623, 4624 and 4625 are not needed for normalizing but are a consequence of constraints on the number of total slide positions on a circular disk for a constant camera frame rate, as will be described. Best use of the spare positions is not defined in this application, although various uses may be seen by those practiced in the art.

Clear reference slides are not needed for intensity normalization in this invention because the signal measured by a given camera pixel as a function of its distance from the ideal sharp edge in the projected patterns has a profile with odd vertical symmetry about a 50% intensity level. Another way of stating the previous is that the measured intensity is always 50% of maximum at the location of a geometrical edge, unlike the case for highly coherent illumination as in prior art of U.S. Pat. No. 5,410,399. In that prior art invention the intensity at the edge location is only 25% of maximum. The location of edges could still be found in that case by the condition of equal measured signals for each slide of a complementary pair, but the sum of intensities was definitely not constant in the region of the edge, leading to a requirement in that prior art for clear reference slides in order to perform accurate interpolation. Using incoherent light as in the present invention provides a high degree of certainty that the sum of received signals from the two patterns in each complementary pair will be a constant, and the same as would have been measured by projection of a clear slide, leading to improved interpolation and more efficient use of space on the code disk.

Very low coherence in the projected light of this invention is assured by the inherent low coherence of the laser diode emission itself plus further integration and scrambling by rectangular light pipes 3400. The result is the desired intensity transition curve with odd symmetry about each projected edge in a complementary pair and no need for clear reference slides. Those who are versed in the art of optical lens design may note that asymmetrical aberrations in the projection lens at large field angles may create some asymmetry in the intensity transition curves. However, accurate location of the edge positions can still be performed. This allows accurate determination of a receiver's location to within one part in 1,024 across the field of view, sufficiently accurate to calculate predictive corrections in the interpolation algorithm of the 3-D processor.

The intensity normalizing process for a sequence of received pulses associated with the projection of a sequence of complementary Gray code pairs on the code disk is defined by the following steps:

Detecting and storing as a first electrical signal the pixel output from the first coded pattern in a first complementary pair;

Detecting and storing as a second electrical signal the output from the same pixel and the second coded pattern in the first complementary pair;

Deriving a normalizing factor R₁ for the first complementary pair that is the sum of the first electrical signal and the second electrical signal;

Repeating the above process for second, third, and additional projected complementary pairs of patterns to calculate second, third, and additional pair-normalizing factors Rₙ up to an N'th value;

Calculating an N-pair average intensity-normalizing factor R_{N} by averaging the number N of said pair-normalizing factors, the averaging formula being

$${R}_{N} = \frac{1}{N} {\sum }_{1}^{N} {R}_{n} ;$$

Using the normalizing factor R_{N} to calculate normalized amplitudes of received pulses from each individual pattern by dividing each individual measured pulse amplitude by R_{N}.

It is convenient for further mathematical derivations and descriptions to introduce the name “stripel” in place of the terms “projector resolution element” or “quantization increment” that are used in prior art patents. It has a close analogy to a camera's focal plane “pixel”, although stripels are one-dimensional long thin strips instead of squares.

Stripel width S is defined at the projector's focal plane in order to maintain the best analogy to camera pixels. The magnified width of a stripel as projected onto an object is defined as S_{OBJ}.

Unlike physical camera pixels, stripels are virtual instead of physical entities. Decoding an entire sequence of light pulses received at a camera pixel is generally required to define the 1-D stripel which contains the pixel's centroid. Each of the two edges of a stripel is defined by a single bar edge somewhere in the sequence. Which patterns they are in and which bars of the various patterns define their edges must be determined during the encoding and decoding processes

The extended Gray code of this invention as exemplified by the pattern sequence illustrated on code disk 46 in FIG. 10 is designed to be optimal for decoding by an interpolation algorithm similar to that of U.S. Pat. No. 5,401,399. It is expected to enable the precision and accuracy of lateral position measurements at the object being profiled to be much better than 5% of a stripel width S_{OBJ}, provided that the signal-to-readout noise in the camera can be kept above 50:1. S_{OBJ} is one part in 1,024 with respect to the encoded extent of a projected slide pattern, so that after interpolation, lateral measurement error can be reduced to one part in 20,000 or less with respect to the width of a projected slide on the object.

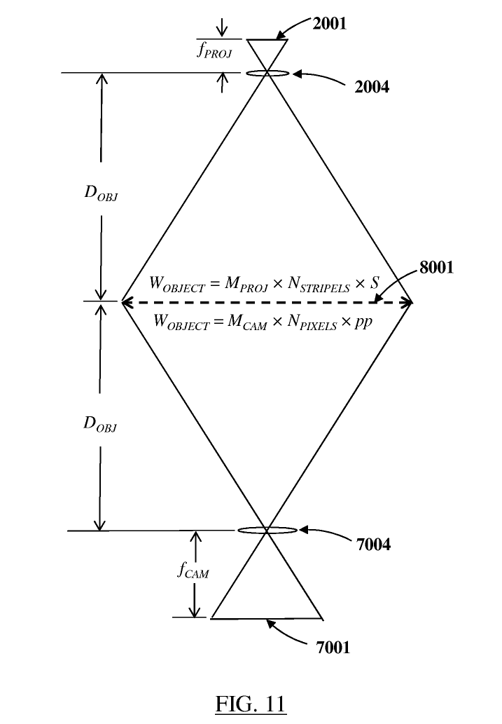

The two essential requirements of the extended Gray code sequence are that stripel width S on the code disk is made proportional to the system's camera pixel pitch pp, and that the minimum bar pattern period on the code disk is made to be eight times S. The proportionality constant is equal to the ratio of camera magnification M_{CAM} to projector magnification M_{PROJ}, where each of these magnifications are defined by equating the field of coverage on an object to be the same for both the system's projectors and cameras, as illustrated in FIG. 11. In FIG. 11 for simplicity the projector and camera are shown as if they were on opposite sides of translucent screen object 8001 and at the same distance from it. The distances and magnifications are the same as in the case where projector and camera are mounted together and viewing a reflective object from the same side.

Again referring to FIG. 11, the same width W_{OBJECT} on the object 8001 is defined both by the width of a projected slide and by the width in one dimension of a camera focal plane array. In this invention, projected stripel size S_{OBJ,} is required to be the same as back-projected camera pixel pitch pp in order to provide for optimum pixel centroid position interpolation inside of an individual stripel in the decoding algorithm of the system 3-D processor 100.

Provided that both projector and camera field of view are at least as large as W_{OBJECT}, the number of magnified stripels N_{STRIPELS} across width W_{OBJECT} in a projected image is the same as the number of magnified pixels N_{PIXELS} across the same width. For a CMOS camera the pixel size and the imaging lens diameter must currently be made large to achieve best sensitivity. The sub-projectors do not have a sensitivity requirement, and furthermore have high brightness laser sources that can use small projection apertures and focal lengths. As a result, the projector's slide dimensions and focal length may be made much smaller and yet provide the same total number of projector stripels as the camera's number of pixels in one dimension. This is illustrated in FIG. 11 where projector slide width 2001 is smaller by roughly a factor of two than the corresponding camera array dimension 7001. As a result, stripel width S at the projector in this invention is roughly one/half of pixel pitch pp in current high frame rate CMOS cameras. The mathematical formula for optimum stripel width S on the slide patterns is given by the formula

$$S = \frac{{M}_{CAM}}{{M}_{PROJ}} \times pp ,$$

where pp is the camera pixel pitch.

The entire extended Gray code sequence of the invention is defined in terms of integer multiples of stripel width S, which is defined in the above equation. There is an additional and important requirement that the minimum spatial period in the sequence of bar patterns must be equal to 8S. In addition, the extended Gray code sequence requires that the slides on the disk be arranged in complementary pairs, where the second slide of a pair will have an optical transmission waveform that is 180 degrees out of phase with that of the first slide; that is, the second slide has a clear strip where the first slide has an opaque bar, and the widths of clear strips and opaque bars are equal. When maximum transmission is 1.0 and the minimum transmission is 0.0, the transmission of the second slide of a pair is simply one minus the transmission of the first slide at the same distance from the edge.

Further to define the extended Gray code sequence of this invention, starting at the least significant (shortest period) end of the sequence there are three pairs of phase-shifted bar-pattern slides, with the phase shift of the first pair in multiples of one stripel being −1, the phase shift of the second pair being zero, and the phase shift of the third pair being +1. The phase shift for each of the remaining slide pattern pairs is zero. For a total number of pairs of this sequence of N_{P}, the total number of stripels N_{STRIPEL} is an even integer 2^{(NP-1)}. For the preferred embodiment of the invention, N_{P} is 11 pairs and N_{STRIPEL} is 1,024 stripels. The stripel width S in the preferred embodiment of the invention is ten micrometers (0.01 mm), such that each slide has an encoded width of 10.24 mm. The stripel lengths and physical bar lengths are each 10.24 mm so that the slides are all squares.

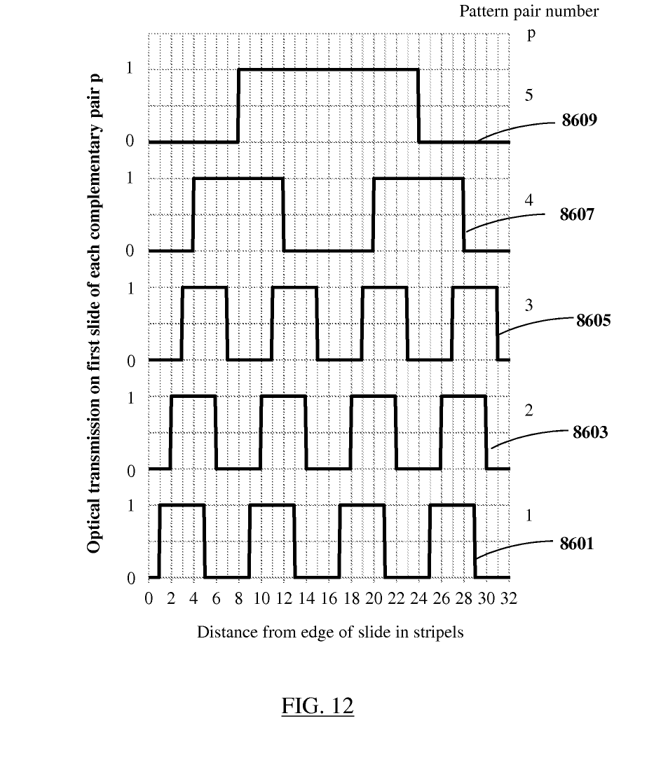

It is convenient to define the entire sequence of the extended Gray code patterns on the code disk in terms of optical transmission square waves as illustrated in FIG. 12. Waveforms 8601, 8603, 8605, 8607, and 8609 represent the transmission of slide patterns 4601, 4603, 4605, 4607, and 4609, which are the first slides in each pair for the first five pairs in the entire sequence of 11 pairs on the code disk of FIG. 10. Periods and phase shifts unique to each pair for the entire sequence in this invention can be described by mathematical formulas. Defining the inner edge of each pattern on the 22 slides as distance x=zero, the defining waveform for optical transmission of the first slide in any complementary pair can be specified by the following parameters in units of S: minimum period MINPER=8, pair number p, and phase shift ps for each pair (ps must be −1, zero, and +1 for the first three pairs and zero for the rest). An Excel® worksheet formula for the transmission Tₚ₁(x) of the first slide of pair number p versus distance x in stripels from the reference edge is

$${T}_{p 1} ( x ) = IF ( RC 2 < A , 0 , IF ( MOD ( x - A , PER ) < PER / 2 , 1 , 0 ) ) , \\ where$$

$$PER = IF ( p < 3 , MIN PER , {2}^{p} ) , \\ \begin{matrix}A = distance to first rising edge of waveform \\ = PER / 4 + ps\end{matrix}$$

Since the this definition results in transmission values of only one or zero, the transmission Tₚ₂(x) of the second slide pattern in a complementary pair is given by the Excel® worksheet formula

Tₚ₂(x)=If(Tₚ₁(x)=1,0,1).

Waveforms for FIG. 12 were calculated by the above Excel® formulas using values of ps for the first three pairs as defined above and MINPER=8. They represent the optical transmission of the first pattern in each pair for p=1, 2, 3, 4, 5. Transmission is plotted versus distance x in units of stripels. Note that the periods of 8601, 8603 and 8605 equal 8 as desired, and that the period of the remaining pairs doubles for each successive value of p.

FIG. 13 shows a portion of the projected minimum period patterns on the object as ideal sharp-edged opaque bars and spaces with period 8S_{OBJ}. Sharp-edged intensity versus lateral distance waveform 9601 corresponds to a portion of waveform 8601 in FIG. 12 for non-magnified slide 4601, and is the waveform that would be created by moving the image of an imaginary pixel of zero width across the ideal image of slide 4601. Vmax corresponds to an optical transmission of 1 on slide 4601, and one period 8 S_{OBJ} on the surface corresponds to a period of 8S on the slide disk. The phase of waveform 9601 is indeterminate in FIG. 13 because the left edge reference of the projected pattern is not shown. However, the patterns on each slide on the code disk have well-defined edges that are all at the same radius from the center of the code disk and therefore serve as accurate universally aligned phase references.

For a real square camera pixel of width pp, the sharp edged square wave 9601 becomes slope-edged trapezoidal wave 10601. This can be seen in FIG. 13 by considering that the amount of light spatially integrated in each pixel will be modified by its relative position to a dark bar edge; specifically, intensity waveform 10601 is a spatial convolution of the pixel area and the projected image intensity. Note that the width and slope of the transitions between zero and Vmax are defined only by the pixel pitch, any imaging blur caused by diffraction, projector and camera lens aberrations, and projector and camera defocus, and as such are independent of waveform period for periods greater than a multiple of the total blur. The minimum wavelength of 8 S_{OBJ} has thus been defined in this invention as the optimum for achieving best interpolation accuracy and requiring the least additional slides in the sequence. As discussed in preceding paragraphs on intensity normalization, pixel pitch will normally be the dominant factor in determining the transition slope and width, with the result that the actual waveforms achieved should be very close to the ideal receiver/decoder algorithm for interpolation defined in the prior art of U.S. Pat. No. 5,410,399.

It should be noted that good design of any electronic camera will ensure that diffraction and lens aberration blur diameter are considerably less than a pixel width. Although it might seem that ignoring lens aberrations and diffraction blur when deriving the 8S bar pattern wavelength dimension could seriously affect decoding accuracy, it is important to note that a small amount of blur will not affect the accuracy of determining in which stripel a camera pixel's center is located, although it could affect interpolation accuracy inside the stripel. Future interpolation algorithms can minimize errors using predictive models of blur size and symmetry as a function of field angle.

FIG. 14 presents waveforms for the same five slide patterns as in FIG. 12, but instead of square wave transmission on the slide patterns, the waveforms are trapezoids that represent the effect of pixel integration of projected intensity on a uniform reflecting object. As in the square wave slide transmission waveforms shown in FIG. 12, the distance x=0 refers to an outer edge of the projected patterns. These waveforms are essentially the waveforms of FIG. 12 convolved with a magnified pixel image. Again, the large number of steep and repeatable slopes in the sequence of trapezoidal waves is optimal for high accuracy interpolation. It is clear from the figure that the first rising edges for waveforms, 10601, 10603, 10605, and 10607 are aligned so that if the vertical spacing of the waveforms were made to be V_{MAX} instead of V_{MAX}/2, the rising edges would form a continuous straight line. The first rising edge of waveform 10609 would not line up with the first rising edge of waveform 10607, but if flipped vertically, the first falling edge of waveform 10601 would do so. Furthermore, vertically flipped falling edges of waveforms 10603 and 10605, plus un-flipped rising edge of waveform 10609 do add to the continuous straight line. Thus far the second slides and second set of waveforms in each complementary pair have not been discussed, but it can easily be seen that similar alignments occur. The same can be said of the waveforms representing the simple differences between the first and pixel outputs for each pair, and also for waveforms representing the normalized differences as described herein. Therefore, the extended complementary Gray code encoding method is clearly compatible with an interpolation routine similar to that described in U.S. Pat. No. 5,410,399, provided that a new algorithm applying specifically to the extended Gray code sequence and defining any required new sign changes for the individual slopes is available. The details of this algorithm are beyond the scope of the present application.

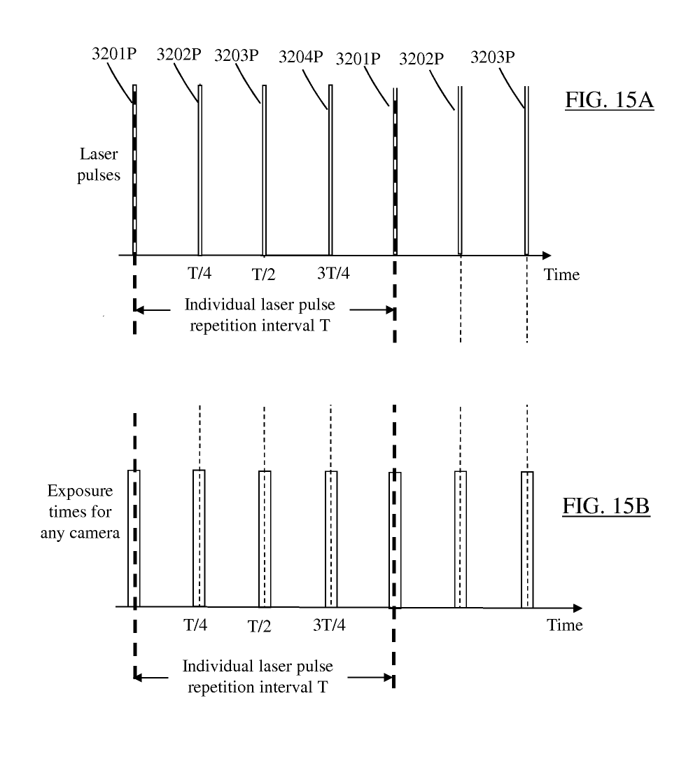

Referring now to the timing diagram of FIG. 15A, the allowable numbers of discrete slide positions on the code disk will be derived. FIG. 15A shows the desired situation in which the arrival times of laser pulses 3201P, 3202P, 3203P, and 3204P as sensed by each camera and which correspond to laser diode sources 3201, 3202, 3203 and 3204, are spaced at equal intervals of T/4, where T is the pulse repetition interval (PRI) for each individual laser. Also shown in FIG. 15B are slightly wider camera exposure times that allow detection of the laser pulses but exclude any interfering reflections or direct illumination from other light sources. Exposure times not much longer than the laser pulses are also important in order to eliminate readout or other noise that would otherwise be integrated during times when there is no incoming signal. If the laser PRI and PRF are not constant, camera frame rates must vary and camera exposure times will have to be longer in order to ensure laser pulse detection, increasing readout noise and increasing system susceptibility to interfering light sources. It is therefore important to design the system such that all cameras can operate at a common constant frame rate and with the shortest exposure times.

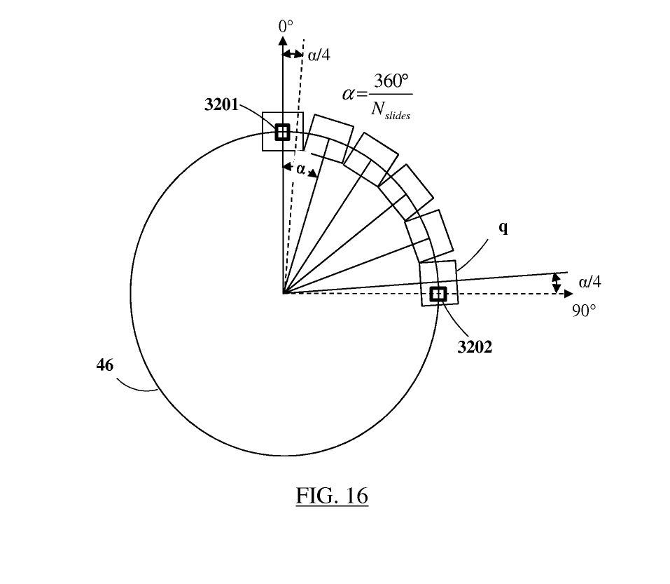

There are only certain numbers of slides on the code disk that will create the desired condition of constant camera frame rate for multiple lasers spaced 90 degrees apart with respect to disk center. Referring to FIG. 16, and assuming clockwise rotation of generic circular code disk 46, it can be seen that when slide q becomes positioned exactly at 90° with respect to the center of the disk, laser 3202 will be pulsed. Slide q was previously at position 0° where it was pulsed by laser 3201. As seen in FIG. 12, slide q will be at an angle of α/4 away from the laser 3202 position at the time laser 3201 is pulsed and a different slide is at 0°. The total angular displacement for slide q in moving from 0° to 90° can be expressed as an integral number m of angular intervals α plus the fractional interval α/4

α(m+¼)=90° (four lasers)

Using the relation α=360°/N_{SLIDES}, the number of slides allowable on the disk for the requirement of having four lasers equally spaced by 90° can now be written as a function of m, assuming that the pulses from four lasers located at 0°, 90°, 180°, and 270° are to be multiplexed:

N_{SLIDES}=4m+1 (four lasers)

Letting m take on integer values 1, 2, 3, 4, 5, 6, 7 . . . etc. it can be seen that the only allowable numbers of slides on the disk for the preferred embodiment with four lasers (four mini-projectors) is 5, 9, 13, 17, 21, 25. 29 . . . , etc. For the preferred embodiment of this invention, m is 6 and N_{SLIDES} is 25.

For an alternate embodiment in which there are only two mini-projectors located at 0° and 90° as for a remote receiver application, the timing of the laser pulses at the 90° position diagram will only show pulses at integral multiples of T/2 instead of T/4. The equations in previous paragraphs for this will have α/4 replaced by α/2, such that the expression for allowable numbers of slides becomes

N_{SLIDES}=4m+2 (two lasers at 90°)

### REFERENCES

U.S. PATENT DOCUMENTS

| | | |
|---|---|---|
| 3,662,180 A | May 1972 | Jorgensen et al. |
| 3,704,070 A | November 1972 | Johnson et al. |
| 3,799,675 A | March 1974 | Johnson et al. |
| 3,866,052 A | February 1975 | Di Matteo et al. |
| 4,100,404 A | July 1978 | Johnson et al. |
| 4,175,862 A | November 1979 | Di Matteo et al. |
| 4,846,577 A | July 1989 | Grindon |
| 4,871,256 A | October 1989 | Grindon |
| 5,410,399 A | April 1995 | Johnson |
| 6,191,850 B1 | February 2001 | Chiang |
| 7,545,516 B2 | June 2009 | Jia et al. |
| 8,014,002 B2 | September 2011 | Keshavmurthy et al. |
| 8,233,156 B2 | July 2012 | Keshavmurthy et al. |
| 8,243,249 B2 | November 2012 | Lin et al. |
| 8,279,334 B2 | October 2012 | Nilson et al. |
| 8,285,025 B2 | October 2012 | Baldwin |

### OTHER REFERENCES

1. G. Sansoni, S. Corini, S. Lazzari, R. Rodella, and F. Docchio, “Three-dimensional imaging based on Gray-code light projection: characterization of the measuring algorithm and development of a measuring system for industrial applications”, Applied Optics, 36, 4463-4472 (1997).
2. Patent Application Publication US 2010/0149551 A1, Jun. 17, 2010, Y. Malinkevich “Structured Light Imaging System and Method”
3. W. H. Press, S. A. Teukolsky, W. T. Vetterling, B. P. Flannery, 1992, Numerical Recipes in C, 2'nd ed. (Cambridge University Press), Chapter 20.2 “Gray Codes”, p 894 ff.

I claim:

1. A 3-D surface profiling system comprising one or more digital cameras and a compound beam projector apparatus for sequential projection of N_{SLIDES} bar pattern slides equally spaced at a common radius on a flat spinning circular disk rotating at a frequency f_disk, where each said bar pattern consists of a periodic arrangement of alternating clear and opaque rectangles, the long side of the rectangles in each pattern being parallel to each other and perpendicular to a radial line from the center of said disk through the center of said rectangles, with each slide being strobe-illuminated at a constant pulse repetition rate of N_{SLIDES} times f_disk by each of four sub-projectors arranged at said common radius and spaced 90 degrees apart with respect to the center of the disk, the number of equally spaced slides N_{SLIDES} on the disk being defined by the formula N_{SLIDES}=(m×4)+1 where m is an integer, resulting in a constant pulse repetition rate at any point sequentially illuminated by the four sub-projectors.

2. A 3-D surface profiling system comprising one or more digital cameras and a compound beam projector apparatus for sequential projection of N_{SLIDES} bar pattern slides equally spaced at a common radius on a flat spinning circular disk rotating at a frequency f_disk, where each said bar pattern consists of a periodic arrangement of alternating clear and opaque rectangles, the long side of the rectangles in each pattern being parallel to each other and perpendicular to a radial line from the center of said disk through the center of said rectangles, with each slide being strobe-illuminated at a constant pulse repetition rate of N_{SLIDES} times f_disk by each of two sub-projectors arranged at a common radius and spaced 90 degrees apart with respect to the center of the disk, such that the requirement for a constant pulse repetition rate at any point illuminated by each of the two sub-projectors is met by the number of equally spaced slides N_{SLIDES} on the disk being defined by the formula N_{SLIDES}=(m×4)+2, where m is an integer.

3. An extended complementary Gray code coding sequence to create structured light for use in a 3-D surface profiling system in conjunction with one or more digital cameras, in which the optical transmission versus distance waveforms of physical patterns at the focal plane of a projector and to be projected in sequence are square waves corresponding to physical patterns of equal width opaque sharp-edged bars and transparent spaces, for which the first three complementary pairs, consisting of six individual bar patterns, have a spatial period MINPER that is eight times the width of the coarse digital resolution element S of the code sequence, which is in turn made to be proportional to the pixel pitch of the associated digital cameras in the system according to the formula:
$$S = \frac{{M}_{CAM}}{{M}_{PROJ}} \times pp ,$$
where
M_{CAM} is the camera's magnification from focal plane to an object
M_{PROJ} is the projector's magnification from focal plane to the same object
Pp is the physical dimension of the camera's focal plane pixel pitch;
the first pattern of the first complementary pair has a phase shift in units of S, ps=−1;
the first pattern of the second complementary pair has a phase shift in units of S, ps=0;
the first pattern of the third complementary pair has a phase shift in units of S, ps=+1;
the fourth and all other subsequent pattern or complementary pairs have phase shifts of zero;
the spatial period of all complementary pairs starting with the fourth pair is given in units of S by
PER=MINPER×2^{p},
where p=pair number starting at the least significant pair in which p=1;
MINPER=8;
the transmission T(x) of the first slide of pair number p versus distance x from the reference edge being represented by the Excel® worksheet formula:
$${T}_{p 1} ( x ) = IF ( RC 2 < A , 0 , IF ( MOD ( x - A , PER ) < PER / 2 , 1 , 0 ) ) , \\ where$$
$$PER = IF ( p < 3 , MIN PER , {2}^{p} ) and$$
$$\begin{matrix}A = distance to first rising edge of the waveform \\ = PER / 4 + ps ,\end{matrix}$$
and the transmission Tₚ₂(x) of the second slide pattern, which is the complement of the first slide in a complementary pair, is given by the Excel® worksheet formula
Tₚ₂(x)=If(Tₚ₁(x)=1,0,1).

4. A structured light projector and receiver system for determining the angular position of the center of either a physical sensor or the center of an image of a camera pixel on a reflecting surface with respect to the optical axis of the projector, in which complementary pairs of patterns are projected and a numerical electrical signal proportional to the pulsed energy received by said sensor or camera pixel for each projected pattern is created, stored and operated on, such that an intensity normalization value R_{N} that is dependent upon the reflectivity and/or slope of the surface being measured is calculated, comprising the steps of:
detecting and storing as a first electrical signal the pixel or receiver output from the first coded pattern in a first complementary pair;
detecting and storing as a second electrical signal the same pixel or same receiver output from the second coded pattern in the first complementary pair;
deriving a normalizing factor R₁ for the first complementary pair that is the sum of the first electrical signal and the second electrical signal;
repeating the above process for second, third, and additional projected complementary pairs of patterns to calculate second, third, and additional pair-normalizing factors Rₙ up to an N'th value;
calculating an N-pair average intensity-normalizing factor R_{N} by averaging the number N of said pair-normalizing factors, the averaging formula being
$${R}_{N} = \frac{1}{N} {\sum }_{1}^{N} {R}_{n} ;$$
using the normalizing factor R_{N} to calculate normalized amplitudes of received pulses from each individual pattern by dividing each individual measured pulse signal by R_{N}.
